(19) United States
(12) Patent Application Publication
(10) Pub. No.: US 2004/0199492 A1
(43) Pub. Date: Oct. 7, 2004

(54) Method of manufacturing dough products via gas injection and accelerational mixing

(76) Inventors: Douglas C. Maniak, Ramsey, MN (US); James S. Thorson, Scandia, MN (US); Chad M. Kubat, Woodbury, MN (US); Doug L. Goedeken, Blaine, MN (US)

Correspondence Address: Amy J. Hoffman, Kagan Binder, PLLC, Suite 200, Maple Island Building, 211 Main Street North, Stillwater, MN, 55082, US

(21) Appl. No.: 10/407,311

(22) Filed: Apr. 4, 2003

(51) Int. Cl. G06F 17/30

(52) U.S. Cl. 707/3

(57) ABSTRACT

Methods for making an uncooked extruded dough product are provided, comprising injecting gas into a pressurized dough before extruding a dough composition of pre-gelatinized starch comprising at least about 75 percent of amylopectin, flour, leavening agent and water through a die under conditions so that the dough composition does not exceed 140° F. throughout the extrusion process. The resulting dough product when cooked has a baked specific volume of greater than about 2.5 cc/g. Products of this process, including filled products, are also provided. Methods for injecting gas into dough for improved extrudability are also provided.

### BACKGROUND OF THE INVENTION

Consumers are always seeking high-quality comestibles that are easy to prepare and easy to eat. When such a product is easy to manufacture, costs may also be low for this product. In the case of bread-like products, the bread portion of the product should have appropriate volume, crumb texture, and mouth feel. The texture of the product should not be too chewy or tough, and the crust should preferably be brown and have the proper texture.

Extrusion processes have been used for the formation of certain dough products. The extrusion process offers an efficient and cost-effective approach for the formation of both cooked and uncooked products. Uncooked extrusion products are prepared by a cold extrusion method, and the resulting products typically are cooked either by the manufacturer or the consumer. Perhaps the most common example of an uncooked or raw extrusion product is pasta. In the past, cold extrusion processes have been used to make dense products. This type of product is a natural outcome of extrusion processes, because extrusion operates by pushing the ingredients, often under significant pressure, up to and through a die. This high-pressure generally causes a composition to release and redistribute any trapped gases present in the composition. Due to this degassing and disproportionation, an extruded composition generally has fewer air-containing pockets than it did before the extrusion process. As used herein the term “disproportionation” refers to the transfer of smaller gas or air bubbles to larger gas or air bubbles and this is generally undesirable. This is problematic if the product being extruded is intended to be a bread-like product. Thus, breads made by an extrusion process using previously known techniques generally have a less desirable texture than like breads that are not made by an extrusion process.

Because of high pressures during extruding, extruding is generally not suited for producing open celled or high specific volume bread-like doughs or dough-products because the die pressure can cause significant shear, degassing, disproportionation and tearing to the cellular structure which holds trapped gases. Bread-like products that have been extruded generally appear translucent because little or no air is trapped in the cell walls. Such products are generally denser than desired. In contrast, products made from batter are easily extruded or deposited. Batters generally have higher water content than dough allowing easier extrusion. Products made from batters such as muffins, cakes and the like do not seem to deleteriously suffer from extruding in the same manner as products made from doughs.

Several references disclose injecting gas(es) into dough and mixing to incorporate the gas in the dough before extruding. U.S. Pat. No. 5,089,283 to Wilson discloses a continuous dough developing process that requires feeding oxygen gas to undeveloped dough. Wilson teaches injecting 0.9 liters of oxygen per kilogram dough. Wilson then requires mixing the dough with a rotor that imparts a high shearing action between the mixer and the dough to develop the dough and distribute the oxygen evenly throughout the dough.

U.S. Pat. No. 4,364,961 to Darley et al. describes subjecting gaseous materials such as carbon dioxide, nitrogen, oxygen, or an admixture of some of these to a mixture of farinaceous product-forming components. Darley et al. disclose a total gas feed to the mixing zone in the range of 1 to about 30 SCF per 100 lbs. dough. The farinaceous product-forming components and injected gas are then subjected to high shear forces within the mixing zone, sufficient to cause simultaneous uniform mixing of the components and dispersion of the inert gas throughout the mix.

U.S. Pat. No. 4,128,480 to Dyson et al. discloses a method of producing particulated stale bread. Dyson et al. state that bread-forming components are mixed in a continuous mixer and carbon dioxide or other gas is injected into the mixed components at a plurality of locations along the length of the mixer. Dyson et al. teach the total gas fed to the mixing zone is in the range of about 1.3 to about 30 SCFH per 100 lbs. of dough. The bread forming components and the injected gas are subjected to high shear forces within the mixing zone, sufficient to cause simultaneous uniform mixing of the components and dispersion of the inert gas throughout the mix.

U.S. Pat. No. 4,568,550 to Fulger et al. discusses injecting a gas such as carbon dioxide or nitrogen into dough during the extrusion process. The conditions during extruding are described as low temperature and low shear conditions. It is suggested that this allows heat sensitive and shear sensitive materials (ingredients) to survive the cooking-extrusion process of this invention.

U.S. Pat. No. 3,041,176 to Baker teaches a process of producing risen dough by providing a flour slurry to a continuous mixing machine to which a gaseous medium is injected to aerate the slurry. Baker discloses injecting air, carbon dioxide, or oxygen into the dough.

Some references discuss extruding at temperatures below 150 degrees Fahrenheit and others discuss incorporating starches into dough formulations to optimize extrusion of dough.

U.S. Pat. No. 6,180,151 to Geng, et al. describes a method of extruding dough products at a temperature less than about 145° F. The dough contains a chemical leavener system that releases carbon dioxide from the formation of the mixture through the extrusion to decrease the density of the extruded dough by at least about 5 percent relative to the corresponding extruded dough without the chemical leavener. The temperature of extrusion is identified as being at a temperature that does not cook or gelatinize the starch within the dough. See column three, lines 1-4. The resulting product has texture approximating pie crust. See column three, line 14.

U.S. Pat. No. 6,068,863 to Dupart, et al. discloses bread products prepared by treating a starch material in water with carbohydrase, so that the starch material is gelatinized. This gelatinized starch is combined with water, a starch material, a vegetable oil and lecithin so that an emulsion is obtained. The emulsion is heated to gelatinize the starch and then dried to obtain a powder. The powder is combined by mixing with wheat flour, sugar, raising agent and water to obtain a dough. The dough may be stored at low temperature or baked. This product is stated to be microwavable.

U.S. Pat. No. 5,049,398 to Saari et al. discloses a method of baking microwave bread. The dough as described therein is made by first prehydrating a defined dough conditioner system and pregelatinized starch to form an emulsion, combining the emulsion with the other ingredients by admixing to form a dough and finish preparing the dough to produce a finished microwave baked bread loaf. See the abstract. The pregelatinized starch component is stated to be provided in an effective amount to improve the table life of the food product upon exposure to microwave heating. See column 3, lines 19-22.

Mixing ingredients so that the dough is homogenous, whether the ingredients are gaseous, solid, or liquid in form, is important. Very generally, mixing can be defined as a process to reduce the non-uniformity of a composition. The basic mechanism involved is to induce physical motion in the ingredients. The two types of mixing that are important are distribution and dispersion. Distributive mixing is used for the purpose of increasing the randomness of the spatial distribution of the particles without reducing the size of these particles. Dispersive mixing refers to processes that reduce the size of cohesive particles as well as randomizing their positions. In dispersive mixing, solid components, such as agglomerates, or high viscosity droplets are exposed to sufficiently high stresses to cause them to exceed their yield stress, and they are thus broken down into smaller particles. The size and shape of the agglomerates and the nature of the bonds holding the agglomerate together will determine the amount of stress required to break up the agglomerates. The applied stress can either be shear stress or elongational stress and generally, it is believed elongational stress is more efficient in achieving dispersion than is shear stress. Therefore, for efficient dispersive mixing, stresses in the high stress region should have a strong elongational component, as well as a shear component.

### SUMMARY OF THE INVENTION

A continuous process for the production of dough is disclosed. The process involves feeding partially or fully developed dough comprising pre-gelatinized starch to a pressurizing chamber, pressurizing the dough, injecting gas into the pressurized dough, and dispersing the gas throughout the dough by accelerating the dough. The process may further include extruding the dough through a die. At least one advantage of the invention is that it allows extrusion of a wider operating range of dough moisture content with greater pressure ranges while still producing desirable bread textures.

A continuous process for the production of dough is disclosed that involves combining flour, water, leavening agent, and pre-gelatinized starch to form a dough. The dough is then placed under pressure and gas is injected into the pressurized dough. In order to disperse the gas through the dough, the dough is forced through an extensional or elongational flow field. The dough is then extruded through a die while maintaining the temperature below 140 degrees Fahrenheit.

In one embodiment of the invention a dough composition is provided that provides improved properties for extrusion. The invention provides a method for making an uncooked extruded dough product, comprising extruding a dough composition comprising pre-gelatinized starch comprising at least about 75 percent amylopectin, flour, leavening agent and water through a die under conditions so that the dough composition does not exceed 140° F. throughout the extrusion process. Additionally, gas is injected into this dough composition and dispersed throughout the dough before it is extruded and individual dough products are formed from the extruded dough composition. The pre-gelatinized starch, flour, leavening agent and water are present in an amount so that the resulting dough product has a baked specific volume (“BSV”) of greater than about 2.5 cc/g. The uncooked product made by this process is also provided.

### DETAILED DESCRIPTION OF PREFERRED EMBODIMENTS

Dough is generally comprised of at least two elements. These include, but are not limited to flour and water. Numerous ingredients are optionally added to dough. These include leavening agents, milk, eggs, sugar, and salt to name a few. In dough, water-gluten solutions constitute the continuous phase in which other ingredients are embedded. A dough is said to be formed when the gluten is either partially or fully developed. The co-pending co-assigned patent application, U.S. Ser. No. 10/068,561 entitled, “METHOD OF EXTRUDING BREAD DOUGH AND PRODUCTS THEREOF” is hereby incorporated in its entirety by reference. It has been found that incorporating pregelatinized starch into dough intended for extrusion is beneficial. Without being bound by theory it is believed that adding pregelatinized starch as a component of the dough creates a more stable dough more able to withstand the harsh conditions of extruding. Thus, pregelatinized starch may be added into the dough used when practicing the invention.

Surprisingly, it has been found that the moisture and pressure range of extrudable doughs is extended when injecting gas into the bread-like products thus expanding the products that may be successfully prepared by using an extrusion process. By using a pregelatinized starch comprising at least about 75 percent amylopectin in the dough composition and extruding the overall composition in a cold extrusion process, it is possible to make extruded products that are truly bread-like. Thus, the dough portion of the final extruded product after baking has a baked specific volume greater than about 2.5 cc/g. In a preferred embodiment, the BSV is greater than about 3.5 cc/g. In another preferred embodiment, the BSV is greater than about 3.0 cc/g. The term “baked specific volume” (“BSV”) is a term of art generally known in the industry to define the inverse of density or fluffiness of a baked good, and is simply the volume of the baked product divided by its weight. The determination of BSV is of course done only on the dough portion of the baked product, and does not include any filling, if present.

The term “baked” specific volume is used herein even though the final products of the present invention are cooked using any known cooking technique that is suitable and desirable for the type of product. The term “cooking” or “cooked” as used herein refers to any appropriate method for preparing a cooked food product, including baking or frying. The term “extrusion” or “extruding” as used herein refers to a process of forcing a dough composition through an orifice under pressure of at least about 50 p.s.i., and typically from about 50 up to about 500 p.s.i.

As noted above, when conventional dough is extruded, the pressure involved in the extrusion process typically leads to degassing of the bread dough. For purposes of the present invention, the term “degassing” refers to both removing the gas from the dough composition and also to redistribution and change in solubility of the gases in the dough. When the dough is placed under pressure, the gases in the dough are forced into solution. When the pressure is released, the gases form larger bubbles that generally result in a less desirable product. A dough having small bubbles or gas cells dispersed evenly throughout the dough results in a good baked product and is highly desired. Dough having large, unevenly dispersed bubbles, lack of bubbles, or thick cell walls is referred to as degassed dough. Degassed doughs generally are not as light, airy, and tender as one would expect or hope for a bread like product. Generally, degassed dough containing products are dense, tough, and have low baked specific volume as described above. Additionally, degassed doughs made from a white flour have a crumb that is yellowish in color, rather than a more desired white crumb of certain embodiments of the present invention.

The starch component of the dough composition to be used in the present invention is a pregelatinized starch, meaning that the starch is gelatinized prior to adding to the other ingredients of the dough composition. While ungelatinized starch is insoluble in water at 20° C. (68° F.), gelatinized starch is water soluble. Thus, a 5 gram sample of gelatinized starch mixed in 100 ml water has no visible insoluble components.

Ungelatinized starch is gelatinized by heating the starch granules in the presence of water, or alternatively exposing the starch to water together with a catalyst (such as acid) or enzyme, under conditions that disrupt the amorphous regions of the starch granule, and permit hydrogen bonding between starch and water molecules. The granules are then able to absorb water and swell, thereby putting greater and greater stress on the crystalline regions. Within a certain range of temperatures, the characteristic of each starch suddenly loses all organized structure and becomes an amorphous network of starch and water intermingled. This is called the gelatinization range, because the granules become tiny gels, or liquid-containing meshworks of long molecules. This range is between about 140-148° F. for wheat flour, and between about 144 and 158° F. for corn starch. Both flour and cornstarch are produced from seeds. Other sources of starch exist which include rice starch and root starches such as arrowroot, tapioca, and potato to name a few. These starches tend to gelatinize at lower temperatures than the seed starches. As yet another source for pregelatinized starch, bread made by the same or a different process may be ground up or otherwise prepared for addition to the dough composition of the present invention in an amount sufficient to act as the source for pregelatinized starch.

The pre-gelatinized starch comprises at least about 75 percent amylopectin, more preferably at least about 80 percent, and most preferably at least about 90 percent of amylopectin. It has surprisingly been found that pre-gelatinized starches having the indicated amount of amylopectin exhibit the desired BSV, and that starches that contain less than about 75 percent amylopectin do not exhibit the desired BSV in the final baked dough product.

Pre-gelatinized starch is preferably present in the dough composition of the invention in amounts of from about 1 to about 12 percent by weight, and more preferably from about 2 percent to about 7 percent by weight of the total dough composition.

Propylene glycol alginate may optionally be added to the dough useful in the present invention. Between about 0.005 to 0.2% by weight of propylene glycol alginate of the total dough composition may be added. Co-assigned co-pending U.S. patent application Ser. No. 10/068,561, entitled, “METHOD OF EXTRUDING BREAD DOUGH AND PRODUCTS THEREOF”, filed on Feb. 5, 2002 discloses a dough composition incorporating propylene glycol alginate and is hereby incorporated by reference in its entirety.

Flour used in the dough of the present invention may be any suitable flour for manufacture of bread. Appropriate flours for use in the present invention include whole grain flours, flours with the bran and/or germ removed, bleached or unbleached, or combinations thereof. Wheat flour is preferred, although non-wheat flours may be used in conjunction with wheat flours or alone if desired. For example, rye, pumpernickel, and rice flour may alternatively be used in the doughs of the present invention.

Gluten is preferably present in the present invention to provide the matrix for accommodating the leavening gas and allowing the food product of the present invention to raise. When the flour that is used the product of the present invention is wheat, gluten is naturally provided in the wheat flour, and no additional gluten need be added to the composition. Other flours may alternatively be used, with the addition of gluten as required so that the end food product may be leavened. It will be appreciated that a highly preferred embodiment of the present invention therefore utilizes wheat flour, because the gluten is automatically included in the food product of the present invention at very low cost and without additional processing steps.

Water is a necessary ingredient in doughs of the present invention. Water is added to the dough as liquid water, ice, or it is added via hydrated ingredients. Ice may be added to supply water to doughs in order to keep the combination cool during mixing. Water is preferably present in the dough in the amount up to about 50 percent by weight, and more preferably between about 25 and 45 percent by weight.

Depending upon the type of leavening desired, a leavening agent can be added to the dough to provide the desired production of carbon dioxide to leaven the dough. The leavening agent may be either yeast or a chemical leavening system, or a combination of the two.

For purposes of the present invention, a chemical leavening system is a combination of chemical ingredients that react to produce carbon dioxide. Preferably, these chemical ingredients are a combination of an acid and a base that react to release carbon dioxide into the dough and thereby increase the volume of the dough. Suitable leavening acids are generally known in the industry and include but are not limited to citric acid, sodium acid pyrophosphate (SAPP), sodium aluminum phosphate (SALP), monocalcium phosphate (MCP), dicalcium phosphate (DCP), sodium aluminum sulfate (SAS), anhydrous monocalcium phosphate (AMCP), dimagnesium phosphate (DMP), dicalcium phosphate dihydrate (DCPD), gluconodelta lactone (GDL) and mixtures thereof. Suitable bases used in leavening agents generally include a carbonate and/or a bicarbonate salt. Suitable carbonate and bicarbonate salts include, for example, sodium carbonate, potassium carbonate, sodium bicarbonate (commonly known as baking soda), potassium bicarbonate, ammonium bicarbonate and mixtures thereof. An example of a preferred chemical leavening system is the combination of sodium bicarbonate and a combination of SAPP and SALP leavening acids.

Yeast may be used either alone or in conjunction with a chemical leavening system to leaven the dough of the present invention. Yeast provides particular flavor and textural benefits, even when not acting as the primary leavening system for the bread product. Any suitable yeast and format thereof may be utilized, including baker's yeast, activated yeast, crumbled yeast, and so forth. When yeast is used as the sole or primary leavening agent in the dough of the present invention, time for proofing the dough may be required after extrusion and before cooking of the raw dough product to obtain the desired baked specific volume. The time required for proofing depends on the composition of the dough, and may be readily determined by the practitioner.

When the leavening agent is used is yeast or a chemical leavening system, the leavening agent preferably is provided as about 1% to about 6% by weight of the dough.

The dough may optionally include fat. Possible fat ingredients include, for example, oils and shortenings. Suitable oils include, for example, soybean oil, corn oil, canola oil, olive oil, sunflower oil, peanut oil, and other vegetable or nut oils. Suitable shortenings include, for example, animal fats such as butter and hydrogenated vegetable oils such as margarine. In preferred embodiments, the dough includes no more than about 10 percent by weight of fat and more preferably from about 0.5 percent by weight to about 6 percent by weight of fat. In other preferred embodiment, such as biscuits, fat may be present in amounts up to about 20 percent by weight. Typically, fats provided in excess of about 10 percent are added in the solid chip form. Fats play a role in both the texture and flavor of the dough product. Depending upon the amount of fat included in the dough composition, the fat may interfere with the gluten structure altering the texture of the dough. Generally, more fatty doughs result in weaker gluten structures producing softer dough products. Additionally, the fat can act as a flavoring agent providing a richer tasting dough. Fats also have a tenderizing effect on bread-like products due to the fact that the lipids act to slow loss of moisture by coating the starch granules. While not being bound by theory, it is further believed that fats may act as a lubricant to enhance extrudability of the dough composition through the extrusion process.

The dough can also include a sweetener, which may be provided either as a natural or artificial sweetener or as a liquid or dry ingredient. Suitable sweeteners include but are not limited to lactose, sucrose, fructose, dextrose, maltose, corresponding sugar alcohols, corn syrup, malt and hydrolyzed corn syrup, maltodextrin, and mixtures thereof. Such sweeteners may act either or both as flavoring agents, texturizing, or browning agents. Sugar can also affect the development of the gluten, because sugar is hygroscopic and competes with the flour proteins for the available water. For this reason, high-sugar doughs tend to take longer to form and to develop. This same characteristic causes the final product to be moister, more tender, and to stay moist and tender longer, since moisture leaves the bread less readily when sugar is there to absorb it. Finally, added sugar enhances browning reactions and will make for a darker crust in a given period of baking.

The dough composition may optionally include additional flavoring agents. Such flavoring agents include but are not limited to such ingredients as salt, milk and milk products, eggs and egg products, cocoa, whey, malt, yeast, yeast extract, inactivated yeast, spices, herbs, vanilla, and commercially available flavorants, such as butter flavor. The optional flavoring agent preferably is present as greater than about 0.1 percent by weight of the dough, and more preferably is from about 0.5 and about 5.0 percent by weight of the dough.

Besides flavoring agents, the dough can further include preservatives, emulsifiers and hydrocolloids. Suitable emulsifiers include, for example, mono- and di-glycerides of fatty acids, propylene glycol mono- and di-esters of fatty acids, glycerol-lacto esters of fatty acids, ethoxylated mono-glycerides, lecithin, protein, and mixtures thereof. Preferred emulsifiers include mono-glycerides and mixtures of propylene glycol mono- and di-esters of fatty acids, mono-glycerides and lecithin. Suitable hydrocolloids assist in building viscosity, binding water, and trapping gases, which include, for example, starches, gums (e.g. xanthan and guar), cellulose, and carageenan. Preservatives, emulsifiers, and hydrocolloids combined comprise preferably less than about 5 percent by weight of the dough, and each preferably between about 0.1 percent and about 2.5 percent by weight of the dough. Suitable preservatives provide shelf-life extension for the baked product, and include, for example, potassium sorbate, sorbic acid, sodium propionate, and sodium diacetate.

Preferred dough compositions used in the method of the present invention comprise ingredients in the following amounts:

| | |
|---|---|
| pregelatinized starch | 2-7% |
| flour | 55-65% |
| yeast or chemical leavening agent | 1-6% |
| water | 28-40%. |

In the case of white, wheat-based breads, an evaluation of the gas cell distribution may be numerically measured by measurement of the crumb color on the L*a*b* scale. Extruded white, wheat-based doughs of the present invention surprisingly have a very acceptable crumb color that is characteristic of bread doughs made in non-extrusion processes. Preferably, the extruded dough product of the present invention, when baked, has a crumb color of at least about 75, and preferably from about 80 to about 85. Crumb color is measured by standard techniques known in the art, such as by using a Minolta Chroma Meter (Model CR-300) Japan. This instrument measures color of objects on the L*a*b* light scale. For purposes of evaluating the crumb of a bread product, only the L* value is used because it is the measure of how “light” an object is. The L*-scale ranges from 0 to 100, with 0 being black and 100 white. Each data point is the average of at least 3 readings, which are taken at different locations in the bread crumb of a single baked bread dough product. It has been found that a white, wheat-based extruded bread of the present invention having a crumb color of at least about 75 exhibits the preferred gas cell distribution and texture. Breads made from non-bleached or non-wheat flours may necessarily have a lower L*a*b* value due to the coloration of ingredients in the dough composition, but also may exhibit the desired gas cell distribution and texture of the baked product of the present invention. Reproducible numerical measurement of such gas cell distribution and texture can be difficult in non-white breads, but determination of whether a product has the desired gas cell distribution and texture is readily made by visual inspection of the bread product. Evaluation of the gas cell distribution and texture of the bread product in non-white breads may be assisted by comparison and correlation to reference white bread products that may be numerically measured by the L*a*b* scale.

During the extrusion process, the temperature of the dough must remain below about 140° F. While not being bound by theory, it is believed that this temperature cap is required to assure that any starches present in other ingredients of the dough composition, such as natural starches present in flour and like, do not gelatinize; and further that any proteins present in the composition do not denature. Maintenance of the dough at this desired temperature is preferably accomplished by ensuring that the temperature of the extruder does not exceed 140° F. Preferably, the dough is maintained at a temperature below about 120° F., and more preferably below about 100° F. As above, this temperature maximum is preferably achieved by maintenance of the temperature of the extruder below the desired temperature of the dough.

The dough as described herein may be extruded using any appropriate extruder for extruding dough, provided that the extrusion is carried out a temperature below about 140° F. For example, conventional single screw food extruders may be used to extrude the present dough compositions. Alternatively, twin screw extruders may be used with the present dough compositions, provided that the twin screw extruder (which is normally used for heated extrusion) is capable of carrying out the extrusion at a temperature below about 140° F. Combination extruder devices, that utilize single screw and twin screw components, are also contemplated.

When combining the ingredients of the dough, the order of addition of ingredients is not critical. In one embodiment of the present invention, all ingredients are simultaneously added to the extruder and mixed in the extruder. This embodiment is particularly useful in providing a continuous process for extrusion of bread dough. Alternatively, various ingredients may be pre-combined to facilitate a continuous process or a batch process. For example, the dry ingredients may first be combined alone to create a “dry blend.” Dry blend ingredients include, but are not limited to flour, leavening agents, pre-gelatinized starch, salt, and sugars. Fat, which may be added as shortening or as oil, may optionally be added directly to the dry blend. A slurry portion may be separately pre-blended. The slurry portion may include, for example, water, protein, and surfactant. Any additional liquid ingredients or those ingredients containing moisture may also be added to the slurry portion. These additional slurry ingredients may include liquid sugars. Flavoring agents are generally added into the slurry portion of the composition. Alternatively, the flavoring agents may be added to the dry blend, particularly if they are substantially anhydrous. The slurry portion is added to the dry blend-oil combination and mixed until a dough is formed. Combining such ingredients is accomplished by any means commonly known in the baking industry. These include, for example, combining the ingredients in a stand mixer fitted with a dough hook or by combining the ingredients in a twin screw premixer.

The following mixing method is preferably employed. The dry blend ingredients are combined and added into a twin screw premixer. The slurry portion is then added into the premixer, followed by addition of the fat component of the dough. The ingredients are combined until gluten is barely formed. That is, mixing continues until the gluten has barely formed so as not to create tough or highly developed dough. The dough is then fed into an extruder and is pressured. At this point the dough may be partially or fully developed. The dough is preferably maintained under pressure in the invention to allow gas to be injected into the dough and more importantly, to remain in the dough. The term “gas” as used herein may refer to a substantially pure form of a given substance in gaseous form or a combination of two or more substances in gaseous form. Maintaining the dough under pressure avoids disproportionation.

The invention may easily be practiced using a standard single screw mixer. A screw extruder is a machine in which material, in the case of the present invention dough, is forced through a contoured orifice or a die in order to shape a material. Screw extruders are generally composed of a housing, which is usually cylindrical barrel section, surrounding a central motor-driven screw. At a first end of the barrel is a feed housing containing a feed opening through which either partially or fully developed dough is introduced into the housing. The screw usually contains raised portions called flights having a larger radial diameter than the screw's central shaft and which are usually wrapped in a helical manner about the central shaft. The dough is then conveyed and pressurized by these screw flights toward the second end of the barrel.

A twin-screw mixer may also be used as the pressurizing chamber. Twin-screw extruders may operate with two screws that may either rotate in the same direction, or they may be counter-rotating. There are some machines that use more than two screws. In counter-rotating twin-screw extruders, dispersive mixing primarily occurs in the intermeshing region between the screws. This action is similar to that in a two-roll mill. This configuration has the disadvantage that the mixing action creates substantial separating forces of the screws. These forces can push the screws against the barrel, if these forces grow too great. This can cause wear of the screws and the barrel, thus the screw speed has to be kept low, with resulting decrease in the throughput of the extruder. Single screw mixers offer the benefits of being a simpler device thus being cheaper to purchase and easier and therefore less expensive to maintain as compared to a twin screw mixer. Single screw mixers also enjoy higher throughput as compared to twin-screw mixers thus being more beneficial and cheaper to use from a manufacturing standpoint.

Optionally, any pressurizing system such as a piston or positive displacement pump may be added before or after a mixer allowing the pressurizing of the dough before it is fed into the final gas injection and mixing chamber. If this is the case, the screw mixer, either single or twin screw, should also maintain the dough pressure in order to allow the injected gas to remain in the dough.

Gas is fed into pressurized dough via a single injection port or via a plurality of injection ports. Simple back check valves are used in the injection port/s to ensure that the dough does not flow backward into the injection port/s deleteriously clogging the port/s. Preferably the check valve is directly in the dough stream so that dough cannot flow back into and clog the injection port/s. Injection apparatuses having flexible back check valves are disclosed in U.S. Pat. Nos. 3,995,617; 4,497,749; and 3,490,392, which are hereby incorporated by reference in their entirety. Any of these types of apparatuses would be suitable when practicing the present invention to avoid clogging of the air injection ports.

The invention contemplates that a single gas is injected into the dough or that a combination of gases is injected into the dough. A combination or mixture of gases may be injected via a single port or alternatively, virtually pure forms of different gases may be injected via different ports. Such a method of practicing the invention would likely require a plurality of injection ports with individual ports allowing injection of different gases.

One benefit of the invention is that it allows precise control of both the type of gases injected into the dough and also the amount of gas injected into the dough. While twin-screw mixers may be run partially full to allow incorporation of air into the dough, this is a very imprecise method of incorporating gas in dough. Likewise, dough hooks or high shear mixers such as pin mixers may be run with less than a full load of dough to attempt to incorporate gas into the dough. However, all of these non-injection methods suffer the same shortfalls in that they are less than precise in the amount and type of gas that is incorporated into the dough.

Inert gases and gases that have low solubility in the dough are preferred when practicing the present invention. The term “inert” as used herein refers to a gas that has low reactivity with the components of the dough. Without being bound by theory, it is believed that one benefit of the invention is that the injected gas allows creation of nucleation sites within the dough. It is proffered that such nucleation sites act as seed sites allowing gases to further develop and create pockets within the dough during leavening. Inert gases and gases that are insoluble within the dough are preferred because they largely do not interfere with the chemistry of the dough. Instead, the gas creates air pockets referred to herein as nucleation sites. If the gas was not inert or was soluble it may either react with the components of the dough thus disappearing from its gaseous state before it is fully incorporated into the dough. Likewise, if the gas is soluble within the dough it goes into solution thereby also disappearing from its gaseous state before it is incorporated into the dough. This is the case with carbon dioxide. When injected into dough carbon dioxide goes into solution thus no longer appearing in its gaseous phase. Without being bound by theory, the gas used in the invention is not intended to expand the dough and is not used to leaven the dough. Instead, the injected gas is believed to create the nucleation sites referred to above.

Preferably nitrogen is injected into the dough. Alternatively, air, argon, xenon, or a combination of any of the named gases is injected into the dough. The solubility of oxygen in water at 20 degrees Celsius is 0.0351 cc oxygen/g water. The solubility of nitrogen in water at 20 degrees C. is 0.016 cc nitrogen/g water. Air generally has a composition of about 80 percent nitrogen and 20 percent oxygen and the solubility of air in water at 20 degrees C. is 0.0198 cc air/g water and the solubility of carbon dioxide in water at 20 degrees C. is 0.901 cc carbon dioxide/g water. The solubility of carbon dioxide in dough at 20 degrees C. is about 1.01 cc carbon dioxide/g dough. As is apparent from reviewing the data, the solubility of carbon dioxide in water is very similar to the solubility of carbon dioxide in dough. Thus, although the data is not available for the solubility of nitrogen, or oxygen, or air in dough one can safely assume that the data is similar to the values for the same gas at the same temperature in water. One can clearly see that the solubility of carbon dioxide in water is substantially higher than the solubility for air, oxygen, or nitrogen in water and one could safely assume that the same is true in dough. For purposes of this application carbon dioxide is said to be soluble in dough whereas air, nitrogen, and oxygen are substantially insoluble in dough. The invention contemplates that other gases other than named above may be useful in the present invention because they are substantially insoluble and inert in dough.

For purposes of this invention a gas having low solubility in dough is one that has less than 0.9 g solubility in water at 20° C.

Another advantage of the invention is that injection of gas into the dough allows extrusion of a wider range of moisture and pressure. As stated earlier, batters are generally easier than dough to extrude and have traditionally been extruded more readily than dough. Dough differs from batter in at least one aspect and that is the amount of water it contains. Batters contain much higher water content thus allowing easier extrusion. Dough, on the other hand, has much lower water content than batter making it less susceptible to extrusion. The method of the invention, aerating pre-gelatinized starch containing dough via injection of gas, allows extrusion of drier dough than has to date been practiced with success.

Gas is fed into the dough at a rate of between about 0.01 and 0.50 standard cubic feet of nitrogen per cubic foot of dough. More preferably the feed rate is between about 0.20 and 0.40 SCF nitrogen per cubic foot of dough, and most preferably between about 0.25 and 0.35 SCF nitrogen per cubic foot of dough.

Dispersion of the injected gas through the dough is a feature of this invention. The invention incorporates an elongational or extensional flow field through which the gas-injected dough is forced. Ideally, the dough is subjected to an elongational flow field thus stretching and accelerating the dough. In this manner the gas is dispersed throughout the dough. It is believed that such mixing provides efficient mixing so that a small amount of work is used to incorporate the small bubbles into the dough. Since less work is used on the dough, the dough does not get over developed and the texture of the final product does not suffer.

Some examples of screw extruders with dispersive mixing elements useful in the present invention are taught in U.S. Pat. No. 6,136,246 to Rauwendaal et al. and U.S. Pat. No. 5,932,159 to Rauwendaal. Both of these references are hereby incorporated by reference in their entirety.

The mixer designs useful to accomplish the mixing useful in the present invention produce regions of high elongational stress thus achieving much better dispersive mixing than standard pin mixers or other types of mixers employing high shear stress. When forcing the dough through the elongational stress inducing regions of the tool the dough is accelerated. This acceleration of the dough is believed to stretch or elongate the dough. It is thought that the air pockets or bubbles that were created when gas was injected into the dough are then broken into smaller bubbles. Repeatedly accelerating the dough breaks the gas bubbles in the dough into smaller and smaller bubbles thus dispersing the gas through the dough.

One way of achieving acceleration of the dough is to have increasingly narrowing passages through which the dough is squeezed. This creates an increase in the average flow velocity of the dough. One such mixer might be a screw mixer design having progressively narrowing passages through which the dough must pass. Multiple passes through such a high stress area would ensure the breakdown of any large gas bubbles. Ideally, a mixer useful in the present invention will have multiple regions of high elongational stress and acceleration requiring forcing the dough through multiple regions of high elongational stress before it is forced through an orifice or die. However, one skilled in the art will also recognize that multiple passes through high stress regions will also ultimately work to break down the gluten of the dough. Therefore, one must optimize the dough composition and development of the dough before gas injection and before dispersion of the gas to ensure that the dough is at an ideal state of development when it is extruded.

The dough product can either be filled or unfilled. In a preferred embodiment, the extruder is fitted with a filling pump, such that dough reaching the die surrounds a filling and forms a coextrusion. Coextrusion is well known in the art. The relative amount of filling and dough is adjusted by the relative speed of the extruder screw and the flow rate of the filling. When a filling is used, a structure of the dough surrounding the filling exits from the die during the extrusion process. The shape and size of the dough product depends on the shape and size of the die. The filled dough product can be cut or otherwise separated to a desired length. Once cut, the dough can optionally be secured, for example by crimping, at one or both ends. Preferably the dough product is secured at both ends to seal the filling within the dough product.

In an alternative embodiment, the dough portion of the product is extruded to create a first dough piece for subsequent deposition of a filling thereon. The filling on the first dough piece is then optionally enclosed by folding the first dough piece or overlaminating the filling on the first dough piece with a second dough piece, followed by securing the dough pieces together, for example by crimping or the like, to seal the filling inside the dough.

The filling, if any, may be a raw or cooked food product. The filling can have a uniform consistency or a chunky consistency. In preferred embodiments, the filling is a highly viscous liquid, suspension or pseudoliquid, i.e., a flowable mixture of particulates and/or liquid that may not normally be a liquid or a suspension. The material preferably is highly viscous such that it will not flow immediately through any imperfection in a dough covering or out from the ends of seams of the product when cut and crimped after exiting the extruder.

The filling can be made from any type or types of food ingredients, including savory or sweet ingredients. Examples of savory ingredients include but are not limited to meat, vegetable, and dairy ingredients. Examples of sweet ingredients include but are not limited to fruit or icing ingredients. Both savory and sweet ingredients may further include spices, herbs, flavoring agents, fats, and the like. The filling may further include such ingredients as preservatives and consistency modifiers such as emulsifiers and thickening agents.

### EXAMPLES

### Example 1

This example illustrates a dough composition of the present invention, together with a process for combining and extruding such dough. The dough of this example is useful for making a filled bread or filled food pocket type product. Examples of such products include a fully encased barbecue sandwich, sloppy joe, or pizza burger. The dough of this example was not filled, but was extruded in the form of a tube that is easily provided with a filling by coextrusion or subsequent filling operation.

The ingredients of the leavening agent were combined in the following amounts:

| | Percent by weight in final |
|---|---|
| Ingredient | dough composition |
| AMCP (anhydrous | 0.24 |
| monocalcium phosphate) | |
| SAPP (sodium acid | 0.28 |
| pyrophosphate) | |
| SALP (sodium aluminum | 0.39 |
| phosphate) | |
| Total | 0.91 |

A dry blend was formed containing the following ingredients:

| | Percent by weight in final |
|---|---|
| Ingredient | dough composition |
| Flour | 48.21 |
| Soda (sodium bicarbonate) | 0.70 |
| Pre-gelatinized Starch* | 4.86 |
| Sucrose | 3.86 |
| Salt | 0.46 |
| Leavening Agent | 0.91 |
| Total | 59.00 |

*“X′Pand R” starch, a waxy cornstarch commercially available from the A. E. Staley Manufacturing Company, Decatur, IL, having an amylopectin content at or near 100%.

A slurry was prepared having the following ingredients and amounts:

| | Percent by weight in final |
|---|---|
| Ingredient | dough composition |
| Water | 36.32 |
| Flavoring agent* | 0.42 |
| Anhydrous monoglyceride | 0.21 |
| Milk protein ** | 1.05 |
| Total | 38.00 |

*Natural butter WONF #12331, manufactured by Degussa Flavors & Fruit Systems.
** Available from DMV International of the Netherlands. MPC-80 is a milk protein.

The dry blend containing the leavening agents was fed into a Buhler (Switzerland) TPX extruder. Oil was added to the twin screw premixer in the amount of 3 weight percent of the total. Slurry was added to the premixer. Nitrogen gas was injected into the dough through a single injection port at the rate of 0.5 liter per minute per 270 pounds of dough per hour. After injection the dough was forced through a 93 mm CRD8 Mixer fitted with an Elongational Pin Mixer both available from Rauwendaal Extrusion Engineering, Inc. located in Los Altos Hills, Calif., and capable of 50% dispersive mixing and 50% distributive mixing. The dough was extruded out of a donut shaped die orifice under a pressure of 50-100 p.s.i., with throughputs of about 270 lbs/hr, to form raw dough product. The raw product was then baked at 350° F. for 18 minutes. The cooked product had a baked specific volume of 3.8 cc/g.

### Example 2

A dough was made in the manner of Example 1, above, with the following ingredients:

The ingredients of the leavening agent were combined in the following amounts:

| | Percent by weight in final |
|---|---|
| Ingredient | dough composition |
| AMCP (anhydrous | 0.24 |
| monocalcium phosphate) | |
| SAPP (sodium acid | 0.30 |
| pyrophosphate) | |
| SALP (sodium aluminum | 0.40 |
| phosphate) | |
| Total | 0.94 |

A dry blend was formed containing the following ingredients:

| | Percent by weight in final |
|---|---|
| Ingredient | dough composition |
| Flour | 47.60 |
| Soda (sodium bicarbonate) | 0.72 |
| Pre-gelatinized Starch* | 5.00 |
| Sucrose | 3.97 |
| Salt | 0.47 |
| Leavening Agent | 0.94 |
| Total | 58.70 |

*“Textaid A,” a starch commercially available from National Starch Company having an amylopectin content of about 75%.

A slurry was prepared having the following ingredients and amounts:

| | Percent by weight in final |
|---|---|
| Ingredient | dough composition |
| Water | 36.69 |
| Oil | 2.98 |
| Flavoring Agent** | 0.40 |
| Anhydrous Monoglyceride | 0.20 |
| Milk Protein *** | 1.00 |
| Total | 41.30 |

**Natural butter WONF #12331, manufactured by Degussa Flavors & Fruit Systems.
*** Available from DMV International of the Netherlands. MPC-80 is a milk protein.

The dry blend containing the leavening agents was fed into a Buhler (Switzerland) TPX extruder, with total throughput of 270 lbs/hr. Nitrogen gas was injected into the dough through a single injection port at the rate of 0.5 liter per minute per 270 pounds per hour of dough. After injection the dough was forced through a 93 mm CRD8 Mixer fitted with an Elongational Pin Mixer both available from Rauwendaal Extrusion Engineering, Inc. located in Los Altos Hills, Calif., and capable of 50% distributive mixing and 50% dispersive mixing. The dough was extruded out of a donut shaped die orifice under a pressure of 50-100 p.s.i. to form raw dough product. The raw product was then baked at 350° F. for 18 minutes. The cooked product had a baked specific volume of 3.2 cc/g.

### Comparative Example

The following blends were prepared:

The ingredients of the leavening agent were combined in the following amounts:

| | Percent by weight in |
|---|---|
| Ingredient | leavening agent blend |
| AMCP (anhydrous | 26.0 |
| monocalcium phosphate) | |
| SAPP (sodium acid | 31.0 |
| pyrophosphate) | |
| SALP (sodium aluminum | 43.0 |
| phosphate) | |

A dry blend was formed containing the following ingredients:

| | Percent by weight in dry |
|---|---|
| Ingredient | blend |
| Flour | 82.0 |
| Soda (sodium bicarbonate) | 1.2 |
| Pre-gelatinized Starch* | 8.0 |
| Sucrose | 6.5 |
| Salt | 0.8 |
| Leavening Agent | 1.5 |

*“X′P and R” starch, a waxy cornstarch commercially available from the A. E. Staley Manufacturing Company, Decatur, IL, having an amylopectin content at or near 100%.

A slurry was prepared having the following ingredients and amounts:

| | Percent by weight in slurry |
|---|---|
| Ingredient | blend |
| Water | 95.5 |
| Flavoring Agent* | 1.1 |
| Anhydrous Monoglyceride | 0.6 |
| Milk Protein ** | 2.8 |

*Natural butter WONF #12331, manufactured by Degussa Flavors & Fruit Systems.
** Available from DMV International of the Netherlands. MPC-80 is a milk protein.

Three different doughs, having varying moisture contents, were prepared. Dough A contained 42% by weight of the slurry blend, 55% by weight of the dry blend and 3% by weight vegetable oil. Dough B contained 37% by weight of the slurry blend, 60% by weight of the leavening blend, and 3% by weight vegetable oil. Dough C contained 35% by weight of the slurry blend, 62% by weight of the leavening agent, and 3% by weight vegetable oil.

The dry blend containing the leavening agents was fed into a Buhler (Switzerland) TPX extruder. Oil was added to the twin screw premixer in the amount of 3 weight percent of the total. The slurry was also added to the premixer. Half of each of the dough compositions A, B, and C, were injected with nitrogen gas through a single injection port at the rate of 0.5 liter per minute per 270 pounds of dough per hour. After injection the dough was forced through a 93 mm CRD8 Mixer fitted with an Elongational Pin Mixer both available from Rauwendaal Extrusion Engineering, Inc. located in Los Altos Hills, Calif., and capable of 50% dispersive mixing and 50% distributive mixing. The remaining half of each dough composition, A, B, and C, were not injected with nitrogen gas but were passed through the same extruder fitted with a 93 mm CRD8 Mixer fitted with an Elongated Pin Mixer as noted. All doughs were extruded out of a donut shaped die orifice under the pressures noted in the table below.

| | Die Pressure | Moisture | Gas | | |
|---|---|---|---|---|---|
| Dough | (psi) | Level | Injection | SV (cc/g) | L*value |
| A | 40 | High 42% | No | 3.6 | N/A |
| A | 40 | High 42% | Yes | 3.6 | N/A |
| B | 100 | Medium 37% | No | 3.0 | 73.6 |
| B | 100 | Medium 37% | Yes | 3.9 | 81.9 |
| C | 150 | Low 35% | No | 3.1 | 75.0 |
| C | 150 | Low 35% | Yes | 3.7 | 82.1 |

The L*value of the high moisture dough (Dough A) is stated as not applicable because it was the same both with and without nitrogen injection.

This Example demonstrates that as doughs are increasingly drier or have a low moisture content, injecting nitrogen into that dough has a positive effect upon the specific volume of the dough and a positive effect upon the L*values. The higher L*values present in the nitrogen injected doughs demonstrate that product is more white than its uninjected counterpart. The higher L*values also demonstrate a greater distribution of small bubbles.

The embodiments described herein are illustrative in nature, and are not intended to limit the scope of the invention. One skilled in the art will recognize that variations are possible without departing from the spirit or scope of the invention.

What is claimed:

1. A method for making an uncooked extruded dough product, comprising:
a. pressurizing a dough composition comprising pre-gelatinized starch comprising at least about 75 percent of amylopectin, flour, leavening agent and water;
b. injecting gas into the pressurized dough;
c. dispensing the gas throughout the dough;
d. extruding the dough through a die under conditions so that the dough composition does not exceed 140 degrees F throughout the extrusion process;
wherein said pre-gelatinized starch, flour, leavening agent and water are present in an amount so that the dough product has a BSV of greater than about 2.5 cc/g.

2. The method of claim 1, wherein said dough composition comprises from about 1 to about 12% by weight of pregelatinized starch.

3. The method of claim 1, wherein said dough composition comprises:
pregelatinized starch 2-7%
flour 55-65%
yeast or chemical leavening agent 1-6%
water 28-40%.

4. The method of claim 1, wherein the dough product has a BSV greater than 3.0.

5. The method of claim 1, wherein the dough is pressurized in a chamber comprising a feeding screw.

6. The method of claim 1, wherein the gas injected into the dough is comprised of gas having low solubility in the dough.

7. The method of claim 1, wherein the gas injected into the dough has low reactivity with the dough.

8. The method of claim 1, wherein the gas injected into the dough is comprised of nitrogen.

9. The method of claim 1, wherein the dough composition does not reach a temperature above about 120° F. throughout the extrusion process.

10. The method of claim 1, wherein said dough product further comprising a filling.

11. The method of claim 1, wherein the step of dispensing the gas throughout the dough is comprised of accelerating the dough.

12. The method of claim 11, wherein the dough is accelerated by forcing the dough through increasingly narrowing passageways.

13. The method of claim 11 wherein the dough is accelerated by forcing the dough through an extensional flow field.

14. The method of claim 1, wherein the extruded dough has a specific gravity of less than 1.

15. The method of claim 8, wherein less than 1 standard cubic foot of nitrogen is injected per cubic foot of dough.

16. The method of claim 10, wherein said dough product is coextruded with a filling to form a filled product.

17. The method of claim 16, further comprising the step of securing said coextruded dough product, thereby sealing said filling within said coextruded dough product.

18. The uncooked extruded dough product made by the method of claim 1.

19. The uncooked extruded dough product made by the method of claim 10.

20. The uncooked extruded dough product made by the method of claim 16.

21. The dough product of claim 16, wherein said dough composition comprises between about 1-12% by weight of pregelatinized starch.

22. The dough product of claim 18, wherein said dough composition comprises:

| | |
|---|---|
| pregelatinized starch | 2-7% |
| flour | 55-65% |
| yeast or chemical leavening agent | 1-6% |
| water | 28-40%. |

23. The dough product of claim 18, wherein the dough product has a BSV greater than 3.0.

24. The dough product of claim 1, wherein the dough product has a specific gravity of less than 1.

25. The dough product of claim 18, wherein the dough product is a white, wheat-based bread product that, when baked, has a crumb color of at least about 75.

26. A process of preparing a cooked extruded dough product, comprising the step of cooking an uncooked extruded dough product of claim 18 without a proofing step.

27. A process of preparing a cooked extruded dough product, comprising the step of cooking an uncooked extruded dough product of claim 19.

28. A process of preparing a cooked extruded dough product, comprising the step of cooking an uncooked extruded dough product of claim 20.

29. A cooked dough product made by the method of claim 26.

30. A cooked dough product made by the method of claim 27.

31. A cooked dough product made by the method of claim 28.

32. The process of claim 1, wherein said acceleration of the dough comprises forcing the dough through at least one progressively narrowing passage.
